(19) United States
(12) Patent Application Publication
(10) Pub. No.: US 2023/0331550 A1
(43) Pub. Date: Oct. 19, 2023

(54) PROCESS AND APPARATUS FOR PRODUCING LOW-NITROGEN SYNTHESIS GAS FROM NITROGEN-CONTAINING NATURAL GAS

(71) Applicant: Linde GmbH, Pullach (DE)

(72) Inventors: Josef SCHWARZHUBER, Wolnzach (DE); Albrecht HEINZEL, München (DE); Thomas HASELSTEINER, Dietramszell (DE); Florian ETTNER, München (DE)

(21) Appl. No.: 18/043,232

(22) PCT Filed: Jun. 23, 2021
(86) PCT No.: PCT/EP2021/025228

§ 371 Date: Feb. 27, 2023

(30) Foreign Application Priority Data
Sep. 3, 2020 (EP) 20020397.4

(51) Int. Cl. C01B 3/56; C01B 3/36; B01D 53/00; F25J 3/02; B01D 53/04

(52) U.S. Cl. CPC C01B 3/56; B01D 53/002; B01D 53/0462; C01B 3/36; F25J 3/0209; F25J 3/0233; F25J 3/0257; B01D 2257/102; B01D 2257/504; B01D 2257/80; C01B 2203/0233; C01B 2203/0244; C01B 2203/0255; C01B 2203/042; C01B 2203/0475; C01B 2203/0495; C01B 2203/1241; C01B 2203/1258; F25J 2205/66; F25J 2220/60

(57) ABSTRACT

Process and apparatus for producing a low-nitrogen synthesis gas from a natural gas containing nitrogen and carbon dioxide, from which water and carbon dioxide are removed in a first temperature swing adsorption plant and subsequently nitrogen is removed in a cryogenic gas fractionator, to give a low-nitrogen, water-free and carbon dioxide-free natural gas, which is next supplied to a thermochemical conversion, so as to recover a crude syngas comprising hydrogen, carbon monoxide, water and carbon dioxide, from which the low-nitrogen synthesis gas is obtained at least by the removal of water and carbon dioxide in a second temperature swing adsorption plant. The characteristic feature here is that at least a part of the low-nitrogen, water-free and carbon dioxide-free natural gas prior to its thermochemical conversion is used as regenerating gas in the regeneration of the first and/or second temperature swing adsorption plant.

The invention relates to a process for producing a low-nitrogen synthesis gas from a natural gas containing nitrogen and carbon dioxide, from which water and carbon dioxide are removed in a first temperature swing adsorption plant and subsequently nitrogen is removed in a cryogenic gas fractionator, to give a low-nitrogen, water-free and carbon dioxide-free natural gas, which is next supplied to a thermochemical conversion, so as to recover a crude syngas comprising hydrogen, carbon monoxide, water and carbon dioxide, from which the low-nitrogen synthesis gas is obtained at least by the removal of water and carbon dioxide in a second temperature swing adsorption plant.

The invention also relates to a device for carrying out the method according to the invention.

In the terminology used herein, a gas mixture is considered to be free of a component if the proportion of this component in the gas mixture does not exceed 0.1 ppmv. In contrast, a gas mixture is referred to as containing a component if the proportion of this component is greater than 0.5 mol%. A gas mixture is considered to be low in a component if the proportion of this component is between 0.5 mol% and 1 ppmv.

Synthesis gases are mixtures of gases containing at least hydrogen and carbon monoxide and can be used to synthesize various products. They are predominantly produced from natural gas, which is thermochemically converted by means of autothermal reforming (ATR), partial oxidation (POX), steam reforming (SMR) or a combination of two or more of these processes that have been known from the prior art for many years. The carbon dioxide-containing natural gas, which usually has a nitrogen content of between 1 to 10 mol%, is prepared, for example, by means of mercury removal, desulfurization, heating and compression to form a natural gas feedstock, which is subsequently converted, with the addition of water and/or carbon dioxide, to a crude syngas that, in addition to carbon monoxide and hydrogen, also comprises larger amounts of carbon dioxide and water and other substances undesirable in the synthesis gas. To obtain a low-nitrogen synthesis gas, nitrogen can be removed either downstream of the thermochemical conversion from the crude syngas produced or already upstream from the natural gas used.

If nitrogen removal takes place downstream of the thermochemical conversion, the desulfurized and mercury-free natural gas is converted with its entire nitrogen load into a nitrogen-containing crude syngas from which the majority of the carbon dioxide is first removed, for example, in an amine scrubber, before water and the remaining carbon dioxide residue are removed in a temperature swing adsorption plant (referred to hereinafter as TSAP for short). The gas mixture thus obtained, consisting largely of hydrogen, carbon monoxide and nitrogen, is then separated with the aid of a cryogenic gas fractionator into crude hydrogen, carbon monoxide and a nitrogen fraction containing combustible substances. After its use as regenerating gas in the TSAP, the crude hydrogen is purified in a pressure swing adsorption plant (PSAP for short) to produce pure hydrogen, at least a part of which is mixed with carbon monoxide from the cryogenic gas fractionator to produce the low-nitrogen synthesis gas.

In the cryogenic gas fractionator, carbon monoxide and nitrogen are separated in a column by rectification, which can only be achieved with a high reflux ratio and/or many separation stages in the column due to the very similar boiling temperatures of the two substances. A further compressor is necessary in order to recirculate the hydrogen-containing residual gas produced during the purification of the crude hydrogen in the PSAP and to use it in the thermochemical conversion or to burn it as a fuel in order to achieve a sufficiently high yield. The resulting high apparatus and energy requirements negatively affect the economic viability of this process variant.

Because the boiling temperatures of nitrogen and methane differ from one another significantly more strongly than those of nitrogen and carbon monoxide, it is relatively easy to remove nitrogen from nitrogen-containing natural gas by rectification in a cryogenic gas fractionator. In particular, the separating column used can be operated in an energetically favorable manner without reflux. An alternative process variant therefore provides for the nitrogen not to be separated from the crude syngas, but rather from the natural gas in a cryogenic process, and to produce, by thermochemical conversion, a likewise low-nitrogen crude syngas from the low-nitrogen natural gas feedstock thus obtained. When processing the crude syngas to produce the low-nitrogen synthesis gas, this process variant still requires a device for removal of carbon dioxide and a TSAP for water and carbon dioxide removal, but a complex cryogenic synthesis gas fractionator, a PSAP for purifying crude hydrogen and a recycle compressor for the hydrogen-containing PSAP residual gas can be dispensed with. However, it is disadvantageous that at least one additional TSAP and possibly a carbon dioxide removal device must be arranged upstream of the cryogenic natural gas fractionator, which TSAP and carbon dioxide removal device prevent water and carbon dioxide from entering the cryogenic natural gas fractionator together with the natural gas, where they would freeze and cause blockages. In particular when carbon dioxide is removed by means of a method based on an aqueous washing agent such as amine scrubbing, water saturation occurs such that a TSAP for water removal is required even if the natural gas used is anhydrous.

Temperature swing adsorption plants used to remove water and carbon dioxide from gas streams have likewise been known for many years to those skilled in the art. The gas stream to be treated is supplied to the TSAP at a first temperature, where it flows through one of a plurality of adsorbers, each of which is filled with an adsorbent material that adsorbs and retains the water and carbon dioxide contained in the gas stream, while allowing other substances such as methane, hydrogen or carbon monoxide to pass through unhindered. As a result, the gas stream exits the adsorber with a water and carbon dioxide content significantly below 1 ppmv.

Because the absorption capacity of the adsorbent material for water and carbon dioxide is limited, the gas stream to the absorber must be interrupted after a certain time before the water or carbon dioxide content of the exiting gas stream exceeds a limit value. While the gas stream to be treated is diverted to another adsorber of the TSAP with adsorbent material still capable of adsorption, the adsorber loaded with water and carbon dioxide is regenerated. For this purpose, the adsorber is flushed with a regenerating gas having a second temperature that is higher than the first temperature at which the gas stream to be treated is fed to the adsorber. The adsorption capacity of the adsorbent material decreases as the temperature increases such that the substances separated are desorbed and removed from the adsorber with the regenerating gas. If crude hydrogen is not available as described above, nitrogen is usually used as regenerating gas, which nitrogen is not adsorbed or is only very poorly adsorbed by the adsorbent material. Because, in addition to water and carbon dioxide, environmentally harmful substances such as methane and carbon monoxide are removed in small amounts from natural gas and crude syngas and pass into the regenerating gas during adsorber regeneration, the loaded nitrogen cannot be released into the atmosphere without treatment. To comply with existing emission limit values, the nitrogen is therefore catalytically post-combusted or disposed of by means of auxiliary firing in a flare or a process furnace.

Because both the first and second TSAP have to be regenerated, the demand for regenerating gas is particularly high in the case of generic synthesis gas production. According to the prior art, low-pressure nitrogen is imported as regenerating gas, the provision and disposal of which are a significant cost factor that has a significant negative impact on the economic viability of synthesis gas production.

The object of the present invention is to provide a method of the generic type and a device for carrying out the said method, which allow the described disadvantages of the prior art to be overcome.

In terms of the process, this object is achieved according to the invention in that at least a part of the low-nitrogen, water-free and carbon dioxide-free natural gas prior to its thermochemical conversion is used as regenerating gas in the regeneration of the first and/or second temperature swing adsorption plant.

The low-nitrogen, water-free and carbon dioxide-free natural gas is suitable as regenerating gas because it consists largely of methane, which is not adsorbed or is adsorbed only to a very small extent by the in a TSAP used for water and/or carbon dioxide removal, in particular at the temperatures prevailing in the adsorbers during the regeneration.

It is known that the adsorbent materials that can be used for water and carbon dioxide removal can catalytically decompose in particular unsaturated hydrocarbons at elevated temperatures, which leads to undesired carbon deposits. Although the low-nitrogen, water-free and carbon dioxide-free natural gas contains practically no unsaturated hydrocarbons, and the risk of decomposition of saturated hydrocarbons is considerably lower, it is proposed to limit the temperatures for the TSAP regenerations according to the invention to values between 170 and 230° C., preferably between 170 and 200° C.

If low-nitrogen, water-free and carbon dioxide-free natural gas is produced from the total amount of the nitrogen and carbon dioxide-containing natural gas provided for the synthesis gas production, the amount of said natural gas is generally sufficient to meet the regenerating gas requirements for the first and second TSAPs. This eliminates the need to supply of a further regenerating gas, for example nitrogen. Excess production of low-nitrogen, water-free and carbon dioxide-free natural gas not required for the TSAP regeneration can be fed directly to the thermochemical conversion. However, it is also possible to produce only as much low-nitrogen, water-free and carbon dioxide-free natural gas from the nitrogen-containing natural gas as is actually required as regenerating gas. Preferably, the part of the nitrogen-containing and carbon dioxide-containing natural gas that is not provided for a water and or carbon dioxide separation is fed directly to the thermochemical conversion after any necessary removal of mercury and/or sulfur components.

During adsorber regeneration, the low-nitrogen, water-free and carbon dioxide-free natural gas used in the TSAP as the regenerating gas is loaded with desorbed substances, which are predominantly water and carbon dioxide. The loaded regenerating gas is expediently fed to the thermochemical conversion, without changing its chemical composition, together with the substances desorbed during adsorber regeneration. For this purpose, the adsorber regeneration is carried out so slowly that only small amounts of water and carbon dioxide pass through the regenerating gas path into the thermochemical converter, where they merely have a negligible effect on the synthesis gas composition. Because water and carbon dioxide are required as reactants or temperature moderators in the thermochemical conversion and are supplied to the thermochemical conversion as feedstocks anyway, an alternative process variant provides a control that ensures that, irrespective of the loading of the regenerating gas, the quantities of water and carbon dioxide required for the process always get to the converter.

If low-nitrogen, water-free and carbon dioxide-free natural gas is to be used for regenerating both the first and second temperature swing adsorption plants, the part of the low-nitrogen, water-free and carbon dioxide-free natural gas, which is intended as regenerating gas, is preferably split into a first and a second partial stream, the first of which is supplied exclusively to the first TSAP and the second of which is supplied exclusively to the second TSAP as regenerating gas. To minimize flow losses, each TSAP is expediently supplied with only the minimum amount of regenerating gas it needs.

However, it is also possible to supply the total amount of the low-nitrogen, water-free and carbon dioxide-free natural gas intended as regenerating gas to regenerate each of the two TSAPs, which natural gas is pre-loaded with desorbed substances in one of the two TSAPs and subsequently used in the other TSAP for adsorber regeneration.

For economic and technical reasons, the carbon dioxide removal using a TSAP is expedient only if the carbon dioxide content of the gas mixture to be treated does not exceed a maximum value, typically 1 mol%. If the nitrogen-containing and carbon dioxide-containing natural gas contains more carbon dioxide than can be expediently removed in a TSAP, one embodiment of the process according to the invention provides that the carbon dioxide content of the nitrogen-containing and carbon dioxide-containing natural gas is reduced to below said maximum value upstream of the TSAP. For this purpose, the natural gas containing nitrogen and carbon dioxide is preferably subjected to acid gas scrubbing such as amine scrubbing. The carbon dioxide removed here can either be released into the atmosphere or put to a material use. Preferably, the removed carbon dioxide is used downstream in the thermochemical conversion.

The process according to the invention is largely independent of the type of thermochemical conversion. For example, the low-nitrogen, water-free and carbon dioxide-free natural gas can be converted to crude syngas by autothermal reforming, partial oxidation, steam reforming or in a combination of at least two of these processes.

Furthermore, the invention relates to an apparatus for producing a low-nitrogen synthesis gas from a natural gas containing nitrogen and carbon dioxide, having a first temperature swing adsorption plant for removing water and carbon dioxide from the natural gas containing nitrogen and carbon dioxide and for recovering a nitrogen-containing, water-free and carbon dioxide-free natural gas, a cryogenic gas fractionator with which a low-nitrogen, water-free and carbon dioxide-free natural gas can be obtained from the nitrogen-containing, water-free and carbon dioxide-free natural gas by the removal of nitrogen, a thermochemical converter for converting the low-nitrogen, water-free and carbon dioxide-free natural gas to crude syngas comprising hydrogen, carbon monoxide, water and carbon dioxide, and a second temperature swing adsorption plant with which water and carbon dioxide can be removed from the crude syngas to obtain the low-nitrogen synthesis gas.

On the apparatus side, the aforementioned object is achieved according to the invention in that the cryogenic gas fractionator is connected to the thermochemical converter via the first and the second temperature swing adsorption plants in such a way that at least a part of the low-nitrogen, water-free and carbon dioxide-free natural gas prior to its reaction in the thermochemical converter can be used as regenerating gas in the regeneration of the first and/or second temperature swing adsorption plant.

Preferably, the connection of the first and second TSAPs to the thermochemical converter is designed such that the part of the low-nitrogen, water-free and carbon dioxide-free natural gas used as regenerating gas can be fed to the thermochemical converter together with the substances desorbed during adsorber regeneration. In particular, the connection does not comprise any means for removing water and/or carbon dioxide from the regenerating gas used.

In a preferred variant of the apparatus according to the invention, the cryogenic gas fractionator is connected to the first and second TSAPs in such a way that a first part of the low-nitrogen, water-free and carbon dioxide-free natural gas intended as regenerating gas can be used as regenerating gas exclusively in the first TSAP and a second part can be used exclusively in the second TSAP. The connection preferably comprises a distributor by means of which the mass flow of the low-nitrogen, water-free and carbon dioxide-free natural gas can be adjusted according to the current regenerating gas requirement of the two TSAPs.

A connection is also possible in which the cryogenic gas fractionator and the two TSAPs are arranged in series such that the total amount of the low-nitrogen, water-free and carbon dioxide-free natural gas intended as regenerating gas can first be fed to one TSAP and then to the other TSAP. In this case, only the last TSAP in the flow direction is expediently directly connected to the thermochemical converter such that the low-nitrogen, water-free and carbon dioxide-free natural gas used as regenerating gas in the two TSAPs and loaded with desorbed substances during adsorber regeneration can be fed into the thermochemical converter.

If the nitrogen-containing and carbon dioxide-containing natural gas contains more carbon dioxide than can be removed in an expedient manner in a TSAP, the apparatus according to the invention is designed with a device arranged upstream of the first TSAP for removing the main part of the carbon dioxide from the natural gas. This apparatus is preferably an acid gas scrubber such as an amine scrubber. Expediently, this device for removing carbon dioxide is connected to the thermochemical converter such that carbon dioxide separated from the natural gas can be fed to the thermochemical converter as a feedstock.

A variant of the apparatus according to the invention provides a bypass line by means of which a part of the natural gas containing nitrogen and carbon dioxide that is not required for producing regenerating gas for the two TSAPs can be fed directly to the thermochemical converter, after possible removal of mercury and/or sulfur components, past the first TSAP, the cryogenic gas fractionator and optionally the device for removing carbon dioxide.

Furthermore, the invention provides that the thermochemical converter is designed as an autothermal reformer or partial oxidation reactor or steam reformer or as a combination of at least two of these apparatuses.

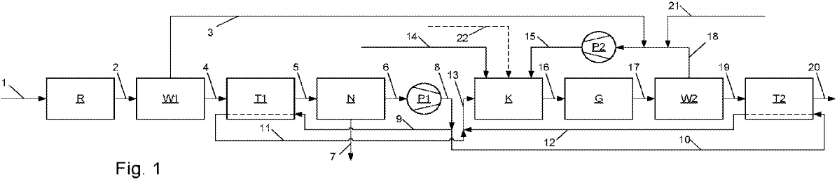

The invention is explained in more detail below using an exemplary embodiment schematically illustrated in FIG. 1.

FIG. 1 shows a variant of the invention in which a low-nitrogen oxide gas is produced from natural gas containing nitrogen and carbon dioxide.

Via line 1, natural gas containing nitrogen and carbon dioxide is fed to the purification device R, where substances such as mercury are removed in a first purification step. The natural gas 2 treated in this way is subsequently fed to an acid gas scrubber W1 for removal of the main part of the carbon dioxide 3 present, which acid gas scrubber is, for example, an amine scrubber. With a reduced carbon dioxide content, the natural gas flows via line 4 to the first TSAP T1, where water and any remaining carbon dioxide are removed and a nitrogen-containing, water-free and carbon dioxide-free natural gas 5 is produced, which is decomposed in the cryogenic gas fractionator N into a low-nitrogen, water-free and carbon dioxide-free natural gas 6 and a fuel gas fraction 7 that is rich in nitrogen. After a pressure increase in the compressor P1, the low-nitrogen, water-free and carbon dioxide-free natural gas 8 is split into a first 9 and a second partial flow 10, of which the first 9 is used as regenerating gas in the adsorber regeneration in the first TSAP T1, while the second part 10 is fed, for the same purpose, to a second TSAP T2 arranged further downstream for gas drying. The two regenerating gas streams 11 and 12 loaded with desorbed water and carbon dioxide are recycled and applied to the thermochemical converter K as a natural gas feedstock via line 13. In the thermochemical converter K, the natural gas feedstock 13 is converted, together with steam 14 as well as carbon dioxide 15 and optionally oxygen 22, to a crude syngas 16 comprising hydrogen, carbon monoxide, water and carbon dioxide, which crude syngas, after cooling in the cooling device G, is conducted via line 17 into a further acid gas scrubber W2, which can likewise be designed as an amine scrubber, for the removal of carbon dioxide 18. In the second TSAP T2, the crude syngas 19 with a reduced carbon dioxide content is purified from water and carbon dioxide residues, wherein a nitrogen-free synthesis gas 20 consisting largely of hydrogen and carbon monoxide is obtained as product. The carbon dioxide 18 separated from the cooled crude syngas 17 is recycled as feedstock into the thermochemical converter K by means of the second compressor P2 and the line 15 after adding carbon dioxide 3 separated from the natural gas 2 and imported carbon dioxide 21 to increase the carbon monoxide production.

1. A process for producing a low-nitrogen synthesis gas from a natural gas containing nitrogen and carbon dioxide, from which water and carbon dioxide are removed in a first temperature swing adsorption plant and subsequently nitrogen is removed in a cryogenic gas fractionator, to give a low-nitrogen, water-free and carbon dioxide-free natural gas, which is next supplied to a thermochemical conversion, so as to recover a crude syngas comprising hydrogen, carbon monoxide, water and carbon dioxide, from which the low-nitrogen synthesis gas is obtained at least by the removal of water and carbon dioxide in a second temperature swing adsorption plant, wherein at least a part of the low-nitrogen, water-free and carbon dioxide-free natural gas prior to its thermochemical conversion (K) is used as regenerating gas in the regeneration of the first and/or second temperature swing adsorption plant.

2. The process according to claim 1, wherein the part of the low-nitrogen, water-free and carbon dioxide-free natural gas used as regenerating gas is fed to the thermochemical conversion together with the substances desorbed during adsorber regeneration.

3. The process according to claim 1, wherein the part of the low-nitrogen, water-free and carbon dioxide-free natural gas, which is intended as regenerating gas, is separated into a first and a second part, the first part being used as regenerating gas exclusively in the first and the second part being used as regenerating gas exclusively in the second temperature swing adsorption plant .

4. The process according to claim 1, wherein carbon dioxide present in the natural gas containing nitrogen and carbon dioxide is removed upstream of the first temperature swing adsorption plant.

5. The process according to claim 1, wherein the thermochemical conversion is carried out as autothermal reforming or partial oxidation or steam reforming or as a combination of at least two of these processes.

6. An apparatus for producing a low-nitrogen synthesis gas from a natural gas containing nitrogen and carbon dioxide, having a first temperature swing adsorption plant for removing water and carbon dioxide from the natural gas containing nitrogen and carbon dioxide and for recovering a nitrogen-containing, water-free and carbon dioxide-free natural gas, a cryogenic gas fractionator with which a low-nitrogen, water-free and carbon dioxide-free natural gas can be obtained from the nitrogen-containing, water-free and carbon dioxide-free natural gas by the removal of nitrogen, a thermochemical converter for converting the low-nitrogen, water-free and carbon dioxide-free natural gas to crude syngas comprising hydrogen, carbon monoxide, water and carbon dioxide, and a second temperature swing adsorption plant with which water and carbon dioxide can be removed from the crude syngas to obtain the low-nitrogen synthesis gas, wherein the cryogenic gas fractionator is connected to the thermochemical converter via the first and the second temperature swing adsorption plant in such a way that at least a part of the low-nitrogen, water-free and carbon dioxide-free natural gas prior to its reaction in the thermochemical converter can be used as regenerating gas in the regeneration of the first and/or second temperature swing adsorption plant.

7. The apparatus according to claim 6, wherein both the first and the second temperature swing adsorption plants are connected to the thermochemical converter in such a way that the part of the low-nitrogen, water-free and carbon dioxide-free natural gas used as regenerating gas can be fed to the thermochemical converter together with the substances desorbed during adsorber regeneration.

8. The apparatus according to claim 6, wherein the cryogenic gas fractionator is connected to the first and the second temperature swing adsorption plants in such a way that a first part of the low-nitrogen, water-free and carbon dioxide-free natural gas intended as regenerating gas can be used as regenerating gas exclusively in the first temperature swing adsorption plant and a second part can be used as regenerating gas exclusively in the second temperature swing adsorption plant .

9. The apparatus according to claim 6, wherein it comprises a device arranged upstream of the first temperature swing adsorption plant for removing carbon dioxide, with which carbon dioxide contained in the containing nitrogen and carbon dioxide can be removed.

10. The apparatus according to claim 6, wherein the thermochemical converter is configured as an autothermal reformer or partial oxidation reactor or steam reformer or as a combination of at least two of these apparatuses.
